(19) United States
(12) Patent Application Publication
(10) Pub. No.: US 2014/0106614 A1
(43) Pub. Date: Apr. 17, 2014

(54) COAXIAL CABLE CONNECTOR WITH A COMPRESSIBLE FERRULE

(71) Applicants: Donald Andrew Burris, Peroia, AZ (US); Jan Michael Clausen, Vordingborg (DK); Kenneth Albert Feese, Tempe, AZ (US); Brian Lyle Kisling, Phoenix, AZ (US); Michael Matzen, Vordingborg (DK); Thomas Dewey Miller, Peoria, AZ (US)

(72) Inventors: Donald Andrew Burris, Peroia, AZ (US); Jan Michael Clausen, Vordingborg (DK); Kenneth Albert Feese, Tempe, AZ (US); Brian Lyle Kisling, Phoenix, AZ (US); Michael Matzen, Vordingborg (DK); Thomas Dewey Miller, Peoria, AZ (US)

(21) Appl. No.: 13/795,780

(22) Filed: Mar. 12, 2013

Related U.S. Application Data
(60) Provisional application No. 61/714,504, filed on Oct. 16, 2012.
(60) Provisional application No. 61/728,474, filed on Nov. 20, 2012.

(51) Int. Cl. H01R 9/05; H02G 15/02; H01R 43/26

(52) U.S. Cl. CPC H01R 9/05; H01R 43/26; H02G 15/025
USPC 439/578; 29/857

(57) ABSTRACT

A coaxial connector for coupling an end of a coaxial cable to a terminal is disclosed. The coaxial cable connector includes a body, a retainer, a coupler, a ferrule, and a shell. The retainer engages the body and rotatably engages the coupler. The ferrule slidingly engages at least a portion of the retainer and at least one portion of the body. The ferrule engages at least a portion of the cable outer conductor. The shell slidingly engages at least a portion of the rear end of the body. A sealing ring engages the rear end of the body. Upon compression of the coaxial cable connector the sealing ring engages the jacket of the coaxial cable.

### RELATED APPLICATIONS

This application claims the benefit of priority under 35 U.S.C. §119 of U.S. Provisional Application Ser. No. 61/714,504 filed on Oct. 16, 2012, the content of which is relied upon and incorporated herein by reference in its entirety.

This application claims the benefit of priority under 35 U.S.C. §119 of U.S. Provisional Application Ser. No. 61/728,474 filed on Nov. 20, 2012, the content of which is relied upon and incorporated herein by reference in its entirety.

This application is related to U.S. application Ser. No. 13/198,765, filed Aug. 5, 2011, which is incorporated herein by reference in its entirety.

This application is related to U.S. application Ser. No. 13/653,095, filed Oct. 16, 2012, which is incorporated herein by reference in its entirety.

This application is related to U.S. application Ser. No. 13/652,969, filed Oct. 16, 2012, which is incorporated herein by reference in its entirety.

### BACKGROUND

1. Field of the Disclosure

The disclosure relates generally to coaxial cable connectors, and particularly to a coaxial cable connector having a compressible.

2. Technical Background

Coaxial cable connectors such as F-connectors are used to attach coaxial cables to another object such as an appliance or junction having a terminal adapted to engage the connector. Coaxial cable F-connectors are often used to terminate a drop cable in a cable television system. The coaxial cable typically includes a center conductor surrounded by a dielectric, in turn surrounded by a conductive grounding foil and/or braid (hereinafter referred to as a conductive grounding sheath); the conductive grounding sheath is itself surrounded by a protective outer jacket. The F-connector is typically secured over the prepared end of the jacketed coaxial cable, allowing the end of the coaxial cable to be connected with a terminal block, such as by a threaded connection with a threaded terminal of a terminal block.

Crimp style F-connectors are known wherein a crimp sleeve is included as part of the connector body. A special radial crimping tool, having jaws that form a hexagon, is used to radially crimp the crimp sleeve around the outer jacket of the coaxial cable to secure such a crimp style F-connector over the prepared end of the coaxial cable.

Still another form of F-connector is known wherein an annular compression sleeve is used to secure the F-connector over the prepared end of the cable. Rather than crimping a crimp sleeve radially toward the jacket of the coaxial cable, these F-connectors employ a plastic annular compression sleeve that is initially attached to the F-connector, but which is detached therefrom prior to installation of the F-connector. The compression sleeve includes an inner bore for following such compression sleeve to be passed over the end of the coaxial cable prior to installation of the F-connector. The end of the coaxial cable must be prepared by removing a portion of the outer braid and/or folding the outer braid back over the cable jacket. The F-connector itself is then inserted over the prepared end of the coaxial cable. Next, the compression sleeve is compressed axially along the longitudinal axis of the connector into the body of the connector, simultaneously compressing the jacket of the coaxial cable between the compression sleeve and the tubular post of the connector. An example of such a compression sleeve F-connector is shown in U.S. Pat. No. 4,834,675 to Samchisen A number of commercial tool manufacturers provide compression tools for axially compressing the compression sleeve into such connectors.

Collars or sleeves within a coaxial cable connector can be compressed inwardly against the outer surface of a coaxial cable to secure a coaxial cable connector thereto. For example, in U.S. Pat. No. 4,575,274 to Hayward, a connector assembly for a signal transmission system is disclosed wherein a body portion threadedly engages a nut portion. The nut portion includes an internal bore in which a ferrule is disposed, the ferrule having an internal bore through which the outer conductor of a coaxial cable is passed. As the nut portion is threaded over the body portion, the ferrule is wedged inwardly to constrict the inner diameter of the ferrule, thereby tightening the ferrule about the outer surface of the cable. However, the connector shown in the Hayward '274 patent cannot be installed by a simple crimp or compression tool; rather, the mating threads of such connector must be tightened, as by using a pair of wrenches. Additionally, the end of the coaxial cable must be prepared by stripping back the outer jacket to expose the conductive grounding sheath and center conductor, then further requires that the conducting grounding sheath be folded back, or everted, all of which takes time, tools, and patience.

FIG. 1 illustrates connector 1000 having coupler 2000, separate post 3000, separate continuity member 4000, and body 5000. In connector 1000, continuity member 4000 is captured between post 3000 and body 5000 and contacts at least a portion of coupler 2000. Coupler 2000 is preferably made of metal, such as brass and plated with a conductive material such as nickel. Post 3000 is preferably made of metal, such as brass, and plated with a conductive material such as tin. cContinuity member 4000 is preferably made of metal such as phosphor bronze and plated with a conductive material such as tin. Body 5000 is preferably made of metal such as brass and plated with a conductive material such as nickel.

### SUMMARY OF THE DETAILED DESCRIPTION

Embodiments disclosed herein include a coaxial connector for coupling an end of a coaxial cable to a terminal, the coaxial cable comprising an inner conductor, a dielectric surrounding the inner conductor, an outer conductor surrounding the dielectric, and a jacket surrounding the outer conductor. The coaxial cable connector includes a body having an internal surface extending between front and rear ends of the body, and defining a longitudinal opening. A retainer has an external surface and engages the body and rotatably engages the coupler. The retainer further has an internal surface in mechanical and electrical communication with a ferrule. The ferrule has an outer surface slidingly engaging at least a portion of the retainer and at least one portion of the body, and an inner surface to engage at least a portion of the cable outer conductor. In an alternate embodiment, the ferrule may engage at least a portion of the cable jacket. A shell has an outer surface and an internal surface, with the internal surface defining an opening through the shell. The internal surface slidingly engages at least a portion of the rear end of the body. A sealing ring is disposed within the shell and engages the rear end of the body. The sealing ring has an internal surface. Upon compression of the coaxial cable connector the sealing ring engages the jacket of the coaxial cable.

Alternatively, upon compression of the coaxial cable connector, the shell may push the sealing ring against the rear end of the body, causing the sealing ring to be compressed both axially and radially and a portion thereof to engage the outer jacket of the coaxial cable. The coaxial cable connector may include a coupling portion rotatably engaging the front end of the retainer. The coaxial cable connector may include a coupling portion rotatably engaging the front end of the body. The shell radially compresses the rear end of the coaxial cable connector body. The coaxial cable connector may be post-less.

In yet another aspect, embodiments disclosed herein include a method for connecting a coaxial cable to a coaxial cable connector. The method includes providing a coaxial cable connector comprising a body having an internal surface extending between front and rear ends of the body, the internal surface defining a longitudinal opening, a retainer having an external surface engaging the body and rotatably engaging a coupler, the retainer further having an internal surface in mechanical and electrical communication with a ferrule. The ferrule has an outer surface that slidingly engages at least a portion of the retainer and the body and has an inner surface to engage at least a portion of the cable outer conductor. Alternatively, the ferrule may engage at least a portion of the cable jacket, A shell has an outer surface and an internal surface. The internal surface defines an opening through the shell, and slidingly engages at least a portion of the rear end of the body. A sealing ring is disposed within the shell and engages the rear end of the body. The sealing ring has an internal surface. Upon compression of the coaxial cable connector, the sealing ring engages the jacket of the coaxial cable.

The method may also include providing a coaxial cable; the coaxial cable comprises an inner conductor, a dielectric surrounding the inner conductor, an outer conductor surrounding the dielectric, and a jacket surrounding the outer conductor; preparing the coaxial cable by exposing a predetermined length of the center conductor and a predetermined length of the outer conductor, the outer conductor covers the underlying dielectric; inserting the prepared coaxial cable through the shell and sealing ring and into the ferrule, wherein the dielectric and the outer conductor terminate at the front end of the ferrule; pushing the ferrule into the retainer thus forcing the ferrule to close about the cable outer conductor, the inner conductor extends beyond the coupling portion and the jacket terminates proximate the rear end of the body; axially compressing (with or without the use of a tool); the coaxial cable connector thereby causing the shell to push the sealing ring against the rear end of the body, causing the sealing ring to engage the outer jacket of the coaxial cable.

Additional features and advantages are set out in the detailed description which follows, and in part will be readily apparent to those skilled in the art from that description or recognized by practicing the embodiments as described herein, including the detailed description, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side cross sectional view of a coaxial cable connector;

FIG. 2 is a partial cross section of a coaxial cable useful for description of the various cable components;

FIG. 2A is a partial cross section of a partially prepared coaxial cable;

FIG. 2B is a partial cross section of a prepared coaxial cable;

FIG. 3 is a partial cross section of acoaxial connector utilizing a post with a coaxial cable partially installed;

FIG. 3A is a partial cross section of a coaxial connector utilizing a post with a coaxial cable further partially installed;

FIG. 4 is a cross sectional view of one embodiment of a coaxial cable connector according to an exemplary embodiment;

FIG. 5 is a partial cross section of a partially installed prepared coaxial cable using one method of preparation according to an exemplary embodiment;

FIG. 5A is a partial cross section of a further partially installed prepared coaxial cable using one method of preparation according to an exemplary embodiment;

FIG. 6 is a partial cross section of the coaxial cable connector of FIG. 4 in an un-compressed or open condition with the prepared coaxial cable of FIG. 2A inserted therein;

FIGS. 6A is a partial cross section of the coaxial cable connector and prepared coaxial cable of FIG. 2A in a final stage of compression.

FIG. 7 is a cross section of a ferrule component;

FIG. 7A is an end schematic view of the ferrule component of FIG. 7 useful for description of the various component constituents;

FIG. 7B is an isometric view of the ferrule component of FIG. 7 useful for description of the various component constituents

FIG. 8 is a cross section of a ferrule component according to an exemplary embodiment;

FIG. 8A is an end schematic view of the ferrule component of FIG. 8 useful for description of the various component constituents;

FIG. 9 is a cross section view of an embodiment of a coaxial cable connector an uncompressed state with the cable shown partially inserted wherein the ferrule alternatively engages the cable jacket;

FIG. 10 is a cross section view of an alternate embodiment of a coaxial cable connector in an uncompressed state wherein a compression ring forms the body radially inwardly;

FIG. 10A is a cross section view of an alternate embodiment of a coaxial cable connector in an compressed state having a cable installed wherein a compression ring forms the body radially inwardly

FIG. 11 is a cross section view of an alternate embodiment of a coaxial cable connector;

FIG. 12 is a schematic end view of a component of the connector of FIG. 11;

FIG. 12A is a cross section view of a component of the connector of FIG. 11;

FIG. 13 is a cross section view of an alternate embodiment of a coaxial cable connector that does not require a compression tool to close the connector; and

FIG. 13 A is a schematic end view of a component of the connector of FIG. 13.

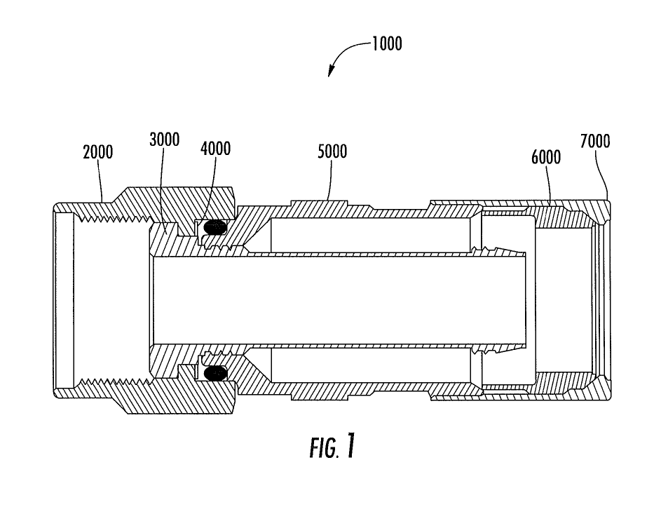

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Rather, these embodiments are provided so that this disclosure will satisfy applicable legal requirements. Whenever possible, like reference numbers will be used to refer to like components or parts.

Coaxial cable connectors are used to couple a prepared end of a coaxial cable to a threaded female equipment connection port of an appliance. The coaxial cable connector may have a post, a moveable post or be postless. In each case, though, in addition to providing an electrical and mechanical connection between the conductor of the coaxial connector and the conductor of the female equipment connection port, the coaxial cable connector provides a ground path from an outer conductor of the coaxial cable to the equipment connection port. The outer conductor may be, as examples, a conductive foil or a braided sheath. Maintaining a stable ground path protects against the ingress of undesired radio frequency (“RF”) signals which may degrade performance of the appliance. This is especially applicable when the coaxial cable connector is not fully tightened to the equipment connection port, either due to not being tightened upon initial installation or due to becoming loose after installation.

For purposes of this description, the term “forward” will be used to refer to a direction toward the portion of the coaxial cable connector that attaches to a terminal, such as an appliance equipment port. The term “rearward” will be used to refer to a direction that is toward the portion of the coaxial cable connector that receives the coaxial cable. The term “terminal” will be used to refer to any type of connection medium to which the coaxial cable connector may be coupled, as examples, an appliance equipment port, any other type of connection port, or an intermediate termination device.

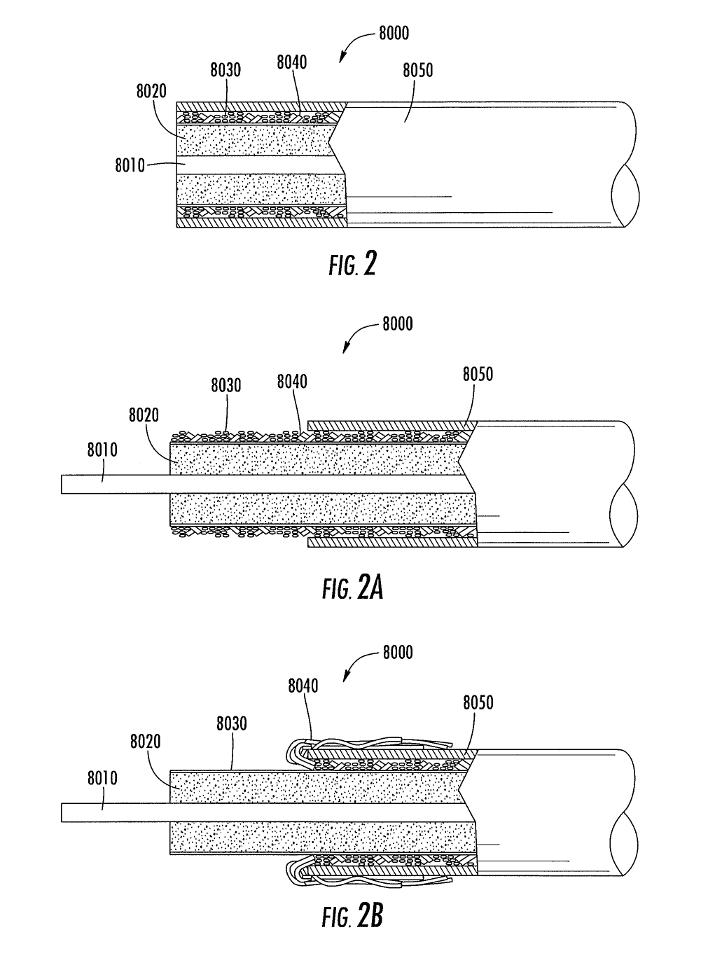

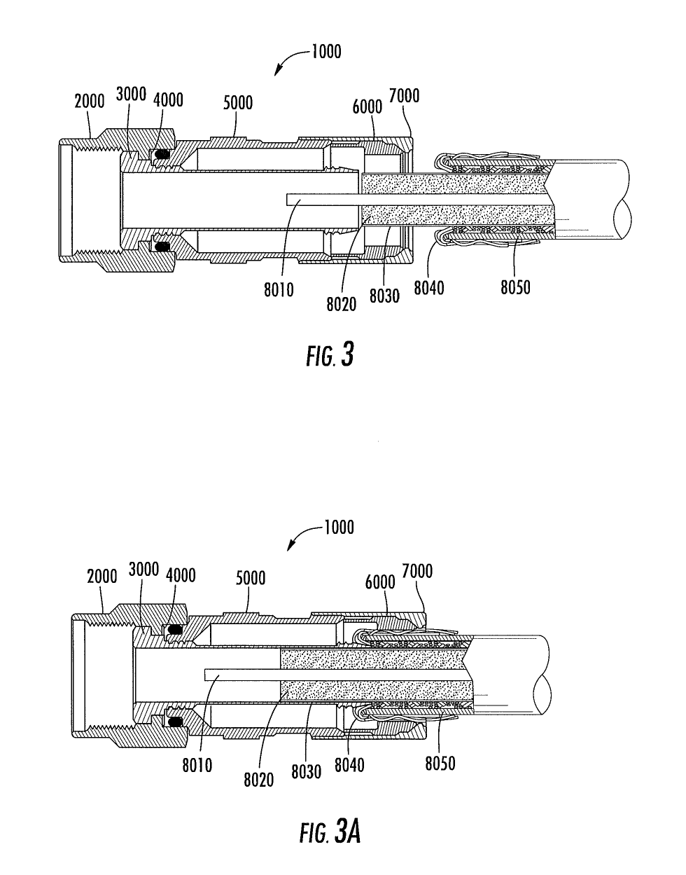

FIGS. 2, 2A and 2B, illustrate a coaxial cable 8000 and the method in which the end of coaxial cable 8000 is prepared for use with coaxial cable connectors. Referring to FIG. 2, coaxial cable 8000 has center conductor 8010 surrounded by a dielectric layer 8020. Dielectric layer (or dielectric) 8020 may also have a foil or other metallic covering 8030. Coaxial cable 8000 has a braided outer conductor 8040 which is covered and protected by jacket 8050. Typically, to prepare coaxial cable 8000 for attachment to a coaxial cable connector, a portion of center conductor 8010 is exposed as illustrated in FIG. 2A. Jacket 8050 is trimmed back so that a portion of dielectric 8020 (and metallic covering 8030) and braided outer conductor 8040 are exposed. Braided outer conductor 8040 is then folded back over jacket 8050 to expose dielectric (and the metallic covering 8030 if present) as shown in FIG. 2B.

FIG. 3 illustrates prepared coaxial cable of FIG. 2B partially inserted into coaxial connector 1000. Inside, body portion 5000 is a post 3000, which is used to secure coaxial cable 8000 relative to coaxial connector 1000. As can be seen in FIG. 3, dielectric 8020 and metallic covering 8030 are inserted into post 3000. Post 3000 can cause problems for the coaxial connector 1000 as well as the installer. First, coaxial cable 8000 must be prepared and dielectric 8020 and metallic covering 8030 aligned with and inserted into post 3000. Second, the post 3000 can skive the dielectric 8020 and metallic covering 8030, tear the braided outer conductor 8040 or the jacket 8050. Additionally, it can be difficult to insert the dielectric 8020 and metallic covering 8030 onto post 3000 due to diametral tolerances of both post 3000 and cable. Further, manufacturing burrs or other damage may be present on the cable insertion end of post 3000 causing further difficulty inserting cable dielectric 8020 and metallic covering 8030 into the post.

FIG. 3A illustrates prepared coaxial cable of FIG. 2B further partially inserted into a coaxial connector 1000 wherein braided outer conductor 8040 and jacket 8050 must pass over post 3000 and through gripping member 6000 during further insertion of cable 8000 into connector 1000. With braided outer conductor 8040 folded back over jacket 8050 the outermost dimension of the prepared cable can become relatively large compared to the passageway provided in gripping member 6000. Additionally, if jacket 8050 is thicker than allowed specification, the outermost dimension of the prepared cable can become relatively even larger compared to passageway provided in gripping member 6000. All this can make it difficult to insert cable 8000 into connector 1000.

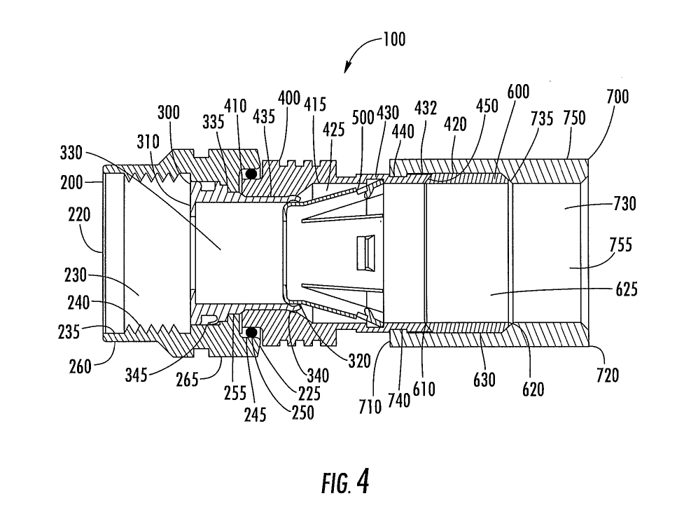

Coaxial cable connector 100 is illustrated in FIG. 4. oaxial cable connector 100 has coupling portion 200, retainer 300, body 400, ferrule 500, sealing member 600, and a shell 700. It should be noted that coaxial cable connector 100 does not have a post that engages coaxial cable between the dielectric and the outer conductor as illustrated above. Additionally, sealing member 600 may be a separate and distinct component from the other components of coaxial cable connector 100. In the embodiment illustrated in FIG. 4, coaxial cable connector 100 is post-less.

Coupling portion 200 has front end 220, back end 225, and opening 230 extending therebetween. Opening 230 of coupling portion 200 has internal surface 235. Internal surface 235 includes threaded portion 240 and channel 245, which is configured to receive elastic ring 250 to seal coaxial cable connector 100. Coupling portion 200 also has inwardly projecting ring 255 to engage rearward facing shoulder 335 of retainer 300,smooth outer surface 260 adjacent front end 220 and hexagonal configuration 265 adjacent back end 225. Coupling portion 200 may be made from any appropriate material, for example, metallic material, such as brass, and may be plated with a conductive, corrosion-resistant material, such as nickel.

Retainer 300 has front end 310 and back end 320 with internal surface 330 extending therebetween. Rearward facing annular surface 335 serves to rotatably retain coupler 200. Barb 340 engages body 400 at step 341to facilitate locating retainer 300 with respect to body 400. Retainer 300 may or may not have optional monolithic grounding flange 345. Retainer 300 may be made from any appropriate material, for example, metallic material, such as brass, and may be plated with a conductive, corrosion-resistant material, such as nickel.

Body 400 has internal surface 415 extending between front end 410 and rear end 420 and defining longitudinal opening 425. Body 400 also has outer surface 432 disposed proximate back end 420 to engage and retain shell 700, inner surface 435 to engage retainer 300, annular groove 440 to retain shell 700, and internal groove 430 to engage ferrule 500. Additionally, body 400 has tapered surface 450 proximate rear end 420 serving to shape or form separate and distinct sealing member 600 when shell 700 is advanced over body 400 forcing sealing member 600 under or into the body 400. Body 400 may be made from any appropriate material, such as, for example, plastic such as acetal.

Sealing member 600 may have front end 610, rear end 620, interior passage 625 and an external shape 630 and be disposed within opening 730 of shell 700. Front end 610 is preferably disposed against rear end 420 of body 400 and rear end 620 is preferably disposed against surface 735 of the shell 700. Sealing member 600 may be made of any appropriate material, for example, a rubber-like plastic material such as silicone or ethylene propylenediene monomer (EPDM).

Shell 700 has front end 710 and back end 720 with annular ring 740 proximate front end 710 to engage and be retained on body 400 by the annular groove 440. Shell 700 has outer surface 750 and internal surface 730 defining an opening 755 therethrough. As can be seen in FIG. 4, opening 755 is larger at front end 710 than at back end 720 due to forward and inward facing surface 735. Shell 700 may be made from any appropriate material, for example, plastic.

Returning to FIGS. 2A and 2B, coaxial cable 8000 is in a prepared state for use with coaxial cable connector 100. Center conductor 8010 is exposed by removing jacket 8050, braided outer conductor 8040, foil or other metallic covering 8030, and dielectric layer 8020. A second portion of jacket 8050 may be removed leaving dielectric layer 8020, foil or other metallic covering 8030, and braided outer conductor 8040 intact. As discussed above with regard to FIG. 2A and 2B, connector 1000 requires braided outer conductor 8040 be folded back over jacket 8050.

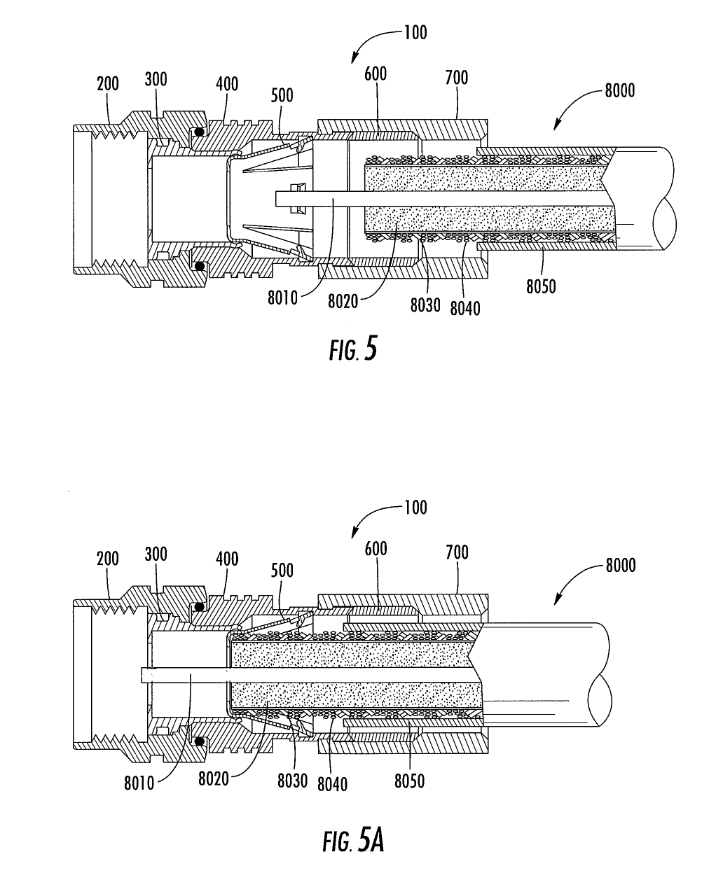

The assembly of coaxial cable connector 100 will now be discussed with reference to FIGS. 5-5A. As can be seen in FIG. 5, prepared coaxial cable 8000 of FIG. 2A is inserted through opening 755 of shell 700, sealing member 600, and partially into the ferrule 500. Clearance between cable 8000 and connector components is provided to facilitate the cable entering connector 100. In FIG. 5A, cable 8000 and, more specifically, cable dielectric layer 8020, foil or other metallic covering 8030, and braided outer conductor 8040 are fully inserted into ferrule 500.

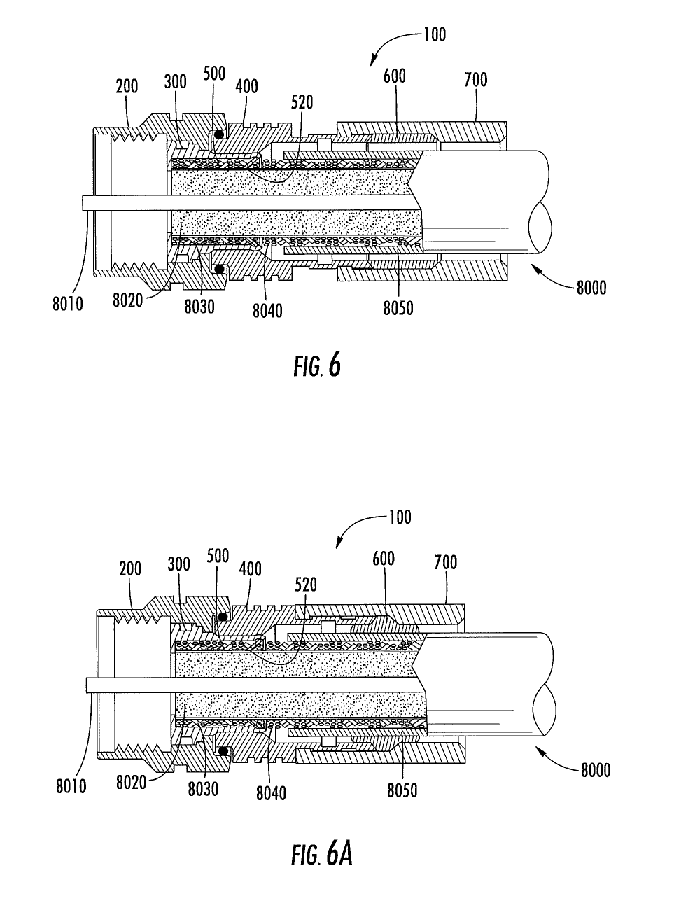

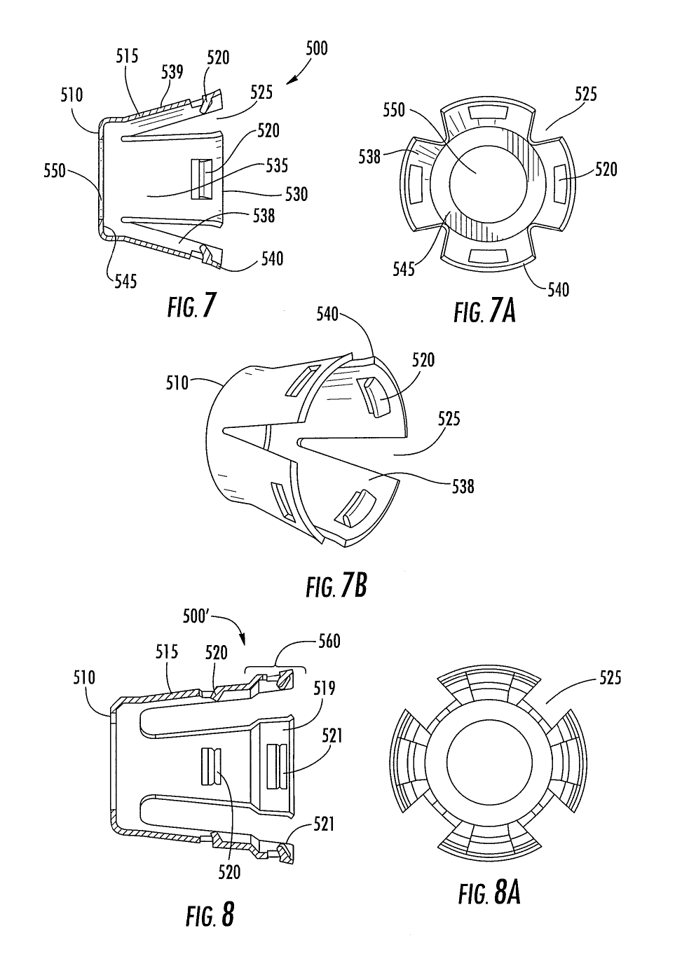

Turning to FIG. 6 and also referencing FIG. 7, cable 8000 is further advanced urging ferrule 500 to move forward while causing ferrule beams 515 to be closed radially inwardly about braided outer conductor 8040 forcing internal surface 538 to contact braided outer conductor 8040 while external surface 539 remains in mechanical and electrical communication with retainer 300. During the closing action, one or more pawls or teeth 520 of ferrule 500 are driven into intimate contact with braided outer conductor 8040 providing both mechanical retention and electrical communication between teeth 520 and braided outer conductor 8040. Additionally, teeth 520 may be forced through braided outer conductor 8040 and contact the foil or other metallic covering 8030.

In FIG. 6A, axial compression of coaxial cable connector 100 has been completed. As can be seen, shell 700 has been moved axially forward and sealing member 600 has been forced into body 400 and further into shell 700 moving sealing member 600 to a compressed state around cable jacket 8050 both sealing body, shell, and cable junction and gripping cable 8000.

Turning to FIGS. 7 through 7B, a detailed description of the constituent features of ferrule 500 provided. Ferrule 500 has front end 510, back end 530, and opening 535 extending therebetween. Opening 535 of ferrule 500 has internal surface 538, which includes teeth 520, vertical face 545 and through bore 550. Ferrule 500 also has a multiplicity of slots 525 that permit flaring resulting in flexible beams 515. Lip 540 engages body groove 430 in shipping position and retainer 300 in closed position. Ferrule 500 may be made from any appropriate material, for example, metallic material, such as brass, and may be plated with a conductive, corrosion-resistant material, such as nickel.

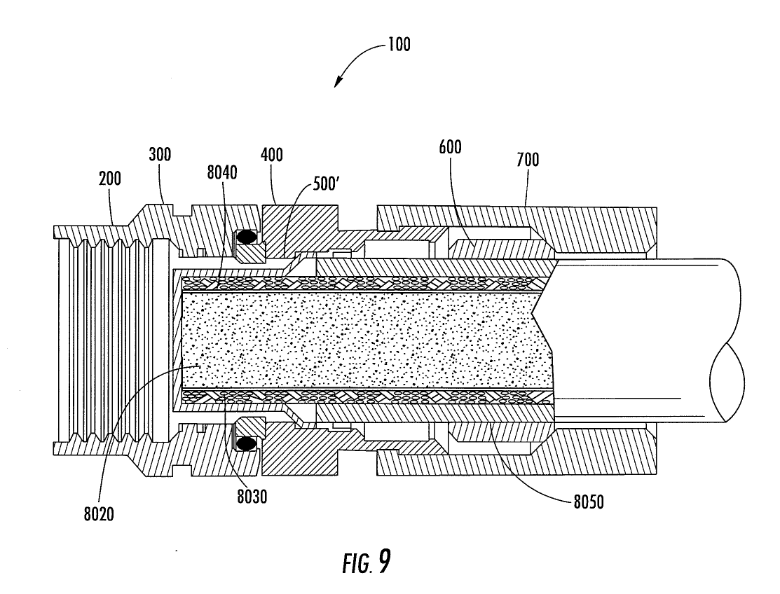

FIGS. 8 and 8A illustrate an alternate embodiment involving ferrule 500′. Ferrule 500′ differs from the ferrule 500 in that ferrule 500′ has extended portion 560 and inner surface 519 to encompass cable jacket 8050. Ferrule 500′ has teeth 521 that capture and grip cable jacket 8050 as illustrated in FIG. 9.

FIG. 9 depicts connector 200 having ferrule 500′, as described above, and having cable 8000 inserted to urge ferrule 500′ to move forward while causing ferrule beams 515 to close radially inwardly about braided outer conductor 8040 which causes internal surface 538 to contact braided outer conductor 8040 while external surface 539 remains in mechanical and electrical communication with retainer 300. During the aforementioned closing action, teeth 520 of ferrule 500′ are driven into intimate contact with braided outer conductor 8040 providing both mechanical retention and electrical communication between teeth 520 and braided outer conductor 8040. Additionally, teeth 520 may be forced through braided outer conductor 8040 and contact foil or other metallic covering 8030. Extended portion 560 of ferrule 500′ and inner portion 519 engage cable jacket 8050 with teeth 521 capturing and gripping cable jacket 8050

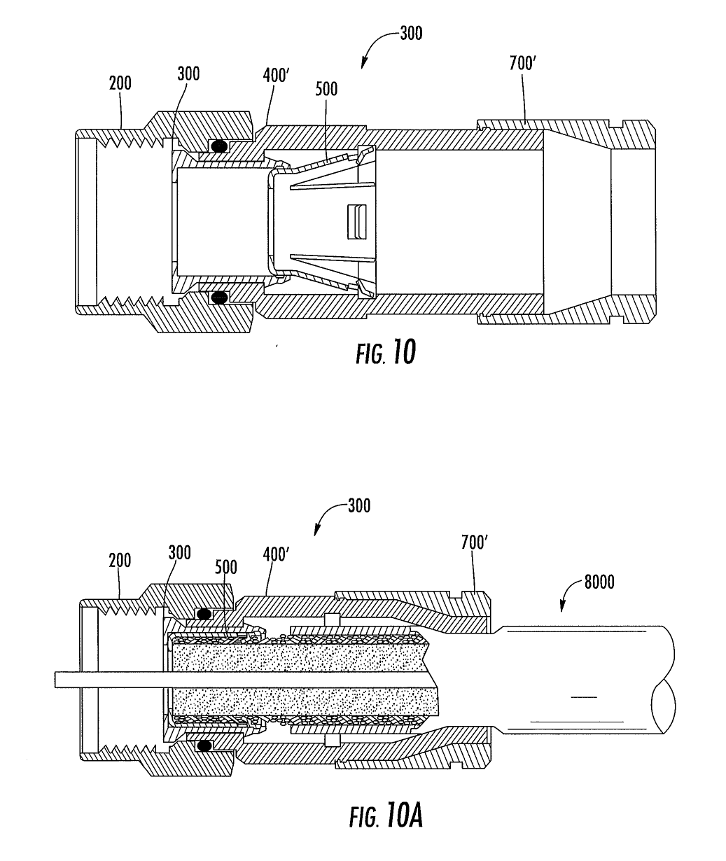

FIG. 10 illustrates coaxial cable connector 300 that eliminates sealing member 600 and employs shell 700′ to compress or radially inwardly form body 400′ around cable 8000 as shown in FIG. 10A.

FIG. 10A illustrates connector 300 with cable 8000 fully inserted and shell 700′ moved forward to compress or radially inwardly form body 400′ around cable 8000.

FIG. 11 is a cross section view of a coaxial cable connector 100′ which has splines 765 in the shell 700″ to limit rotational movement of the cable 8000 within the connector 100′. Slots 766 are illustrated and discussed below.

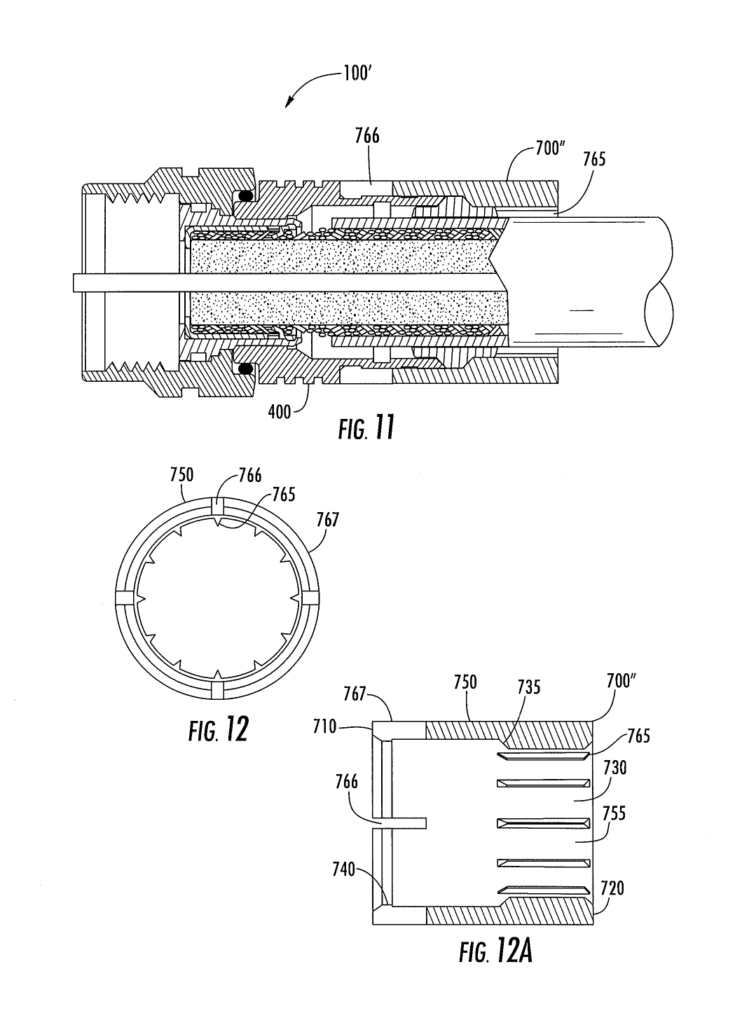

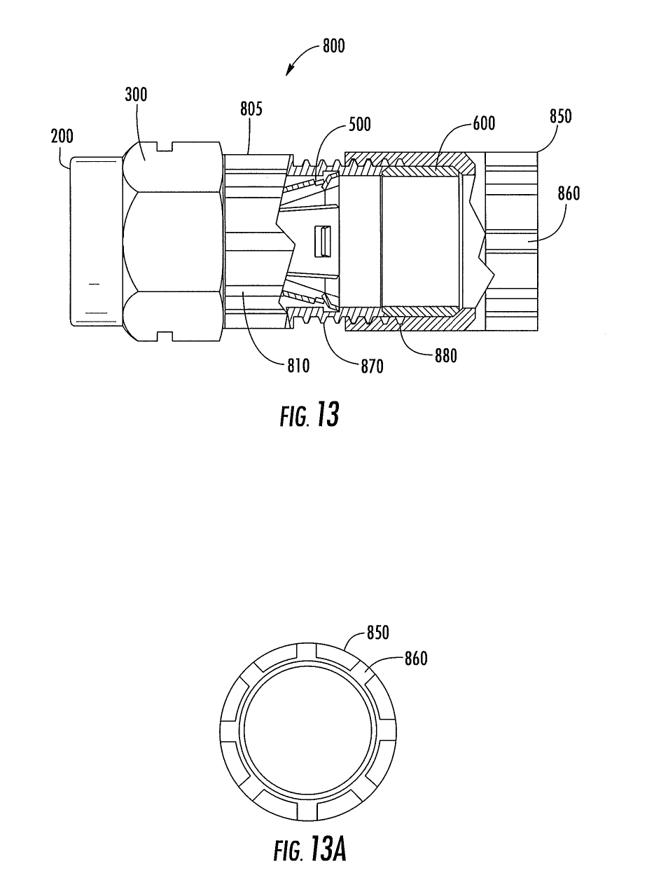

FIG. 12 &12A illustrate views of shell 700″. FIG. 12 is a schematic end view of shell 700″ and FIG. 12A is a cross sectional view of shell 700″. Shell 700″ comprises internal splines 765 and slots 766. Slots 766 permit flexible beams 767 to conform to contours of body 400 while maintaining a tight gripping action.

FIG. 13 is a cross sectional view of coaxial cable connector 800 that does not require a compression tool to close connector 800. Connector 800 has body 805 and shell 850. Body 805 comprises gripping ribs 810 and external helical inclined plane 870. Shell 850 comprises gripping ribs 860 and internal helical inclined plane 880 designed to engage and co-act with external helical inclined plane 870 to advance shell 850 over body 805 when shell 850 and body 805 are radially moved relative to one another. The corresponding external helical inclined plane 870 and internal helical inclined plane 880 may be similar to a standardized thread system such as an SAE thread, or an Acme thread requiring multiple revolutions to achieve complete advancement of shell 850 over body 805 or, alternatively, may be more of an elongated spiral in nature requiring less than one full revolution for complete advancement of shell 850 over body 805.

Alternatively, helical inclined plane system may consist of an external helical inclined plane on body 805 with a single tooth or peg as a follower as part of shell 850. The inverse is possible as well, where helical inclined plane system may consist of an internal helical inclined plane on shell 850 with a single tooth or peg as a follower as part of body 805. Gripping ribs 810 and 860 serve for applying hand-torque to the connector 800 during installation onto a coaxial cable and may be in any number of configurations that provides an improved grippable surface, such as a knurl, diamond or other suitable pattern. FIG. 13A is a schematic end view of a component of connector 800 of FIG. 13 illustrating the plurality gripping ribs 860.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A coaxial connector for coupling an end of a coaxial cable to a terminal, the coaxial cable comprising an inner conductor, a dielectric surrounding the inner conductor, an outer conductor surrounding the dielectric, and a jacket surrounding the outer conductor is disclosed, the coaxial cable connector comprising:
a body having an internal surface extending between front and rear ends of the body, the internal surface defining a longitudinal opening;
a ferrule engaging at least a portion of the body, wherein the ferrule has an inner surface adapted to receive a coaxial cable inserted into the connector and engage at least a portion of the outer conductor of the coaxial cable.

2. The coaxial cable connector of claim 1, wherein the ferrule comprises at least one beam which radially closes about the outer conductor of the coaxial cable when the coaxial cable is received by the ferrule.

3. The coaxial cable connector of claim 2, wherein the at least one beam includes a first pawl extending from the internal surface of the ferrule, wherein the first tooth is driven into contact with the outer conductor of the coaxial cable when the at least one beam closes about the coaxial cable providing mechanical retention and electrical communication between the first tooth and the outer conductor.

4. The coaxial cable connector of claim 3, wherein the at least one beam comprises an extended portion, and wherein the extended portion includes a second tooth extending from the internal surface of the ferrule, and wherein the second tooth captures and grips the coaxial cable jacket when the at least one beam closes about the coaxial cable.

5. The coaxial cable connector of claim 2, wherein the at least one beam comprises a plurality of beams.

6. The coaxial cable connector of claim 1, wherein the ferrule has an outer surface, and wherein the ferrule outer surface engages the body.

7. The coaxial cable connector of claim 6, wherein the outer surface of the ferrule slidably engages the body.

8. The coaxial cable connector of claim 1, further comprising a retainer.

9. The coaxial cable connector of claim 8, wherein the ferrule has an outer surface, and wherein the ferrule outer surface engages the retainer and wherein the ferrule is in mechanical and electrical communication with the retainer.

10. The coaxial cable connector of claim 9, wherein the outer surface of the ferrule slidably engages the retainer.

11. The coaxial cable connector of claim 9, wherein the ferrule remains in in mechanical and electrical communication with the retainer when the ferrule inner surface is engaged with the coaxial cable outer conductor.

12. The coaxial cable connector of claim 10, wherein the ferrule comprises at least one beam which radially closes about the outer conductor of the coaxial cable when the coaxial cable is received by the ferrule, and wherein the ferrule remains in in mechanical and electrical communication with the retainer when the at least one beam radially closes about the outer conductor of the coaxial cable.

13. The coaxial cable connector of claim 8, wherein the retainer comprises a monolithic grounding flange.

14. The coaxial cable connector of claim 1, further comprising a shell having an outer surface and an internal surface, the internal surface defining an opening through the shell, wherein the internal surface slidingly engages at least a portion of the rear end of the body.

15. The coaxial cable connector of claim 14, further comprising a sealing ring disposed within the shell and engaging the rear end of the body, the sealing ring having an internal surface, and wherein upon compression of the coaxial cable connector the sealing ring engages the jacket of the coaxial cable.

16. The coaxial cable connector of claim 14, wherein the shell comprises splines which grip the jacket of the coaxial cable.

17. The coaxial cable connector of claim 15, wherein the shell comprises a plurality of flexible beams separated by slots, wherein the beams provide a gripping action on the jacket of the coaxial cable while allowing the shell to form to the contours of the body.

18. A method of terminating a coaxial cable, comprising:
providing a coaxial cable connector comprising a body, a retainer, and a ferrule;
engaging by the retainer the body;
slidably engaging by the ferrule at least a portion of the retainer and at least a portion of the body, wherein the ferrule is in mechanical and electrical communication with the retainer;
receiving a coaxial cable inserted into the connector and engaging at least a portion of the outer conductor of the coaxial cable by the ferrule.

19. The method of claim 18, wherein the ferrule has an inner surface and comprises at least one beam, and wherein the at least one beam has a tooth extending inwardly from the inner surface of the ferrule.

20. The method of claim 19, further comprising capturing and gripping by the tooth the jacket of the coaxial cable.

21. The method of claim 19, wherein the at least one beam comprises a plurality of beams.

22. The method of claim 18, further comprising maintaining by the ferrule the mechanical and electrical communication with the retainer when the ferrule inner surface is engaged with the coaxial cable outer conductor.
